(19) United States
(12) Patent Application Publication
(10) Pub. No.: US 2024/0257372 A1
(43) Pub. Date: Aug. 1, 2024

(54) COMPUTER PROGRAM PRODUCT, INFORMATION PROCESSING APPARATUS, AND INFORMATION PROCESSING METHOD

(71) Applicant: KABUSHIKI KAISHA TOSHIBA, Tokyo (JP)

(72) Inventors: Atsushi KAWASAKI, Yokohama (JP); Tomoki WATANABE, Inagi (JP)

(73) Assignee: KABUSHIKI KAISHA TOSHIBA, Tokyo (JP)

(21) Appl. No.: 18/456,170

(22) Filed: Aug. 25, 2023

(30) Foreign Application Priority Data
Jan. 30, 2023 (JP) 2023-011830

(51) Int. Cl. G06T 7/564; G06T 7/73; G06T 17/00

(52) U.S. Cl. CPC G06T 7/564; G06T 7/75; G06T 17/00; G06T 2207/10028; G06T 2207/30256; G06T 2210/56

(57) ABSTRACT

A computer program product includes a computer-readable recording medium on which programmed instructions causing a computer to perform the following processing are recorded. The computer specifies a reference coordinate system of a three-dimensional position. The computer detects, from an image data, an area in which a designated target object is included. The computer extracts, from three-dimensional point cloud data, extraction point cloud data representing a three-dimensional position of an object in a target area. The computer generates target object information. A shape and an orientation of a first portion of the designated target object are defined. The orientation is defined for one of coordinate axes in the reference coordinate system. The computer generates the target object information by fitting the target object model to the extraction point cloud data under a condition that an orientation of the target object model matches an orientation defined for the first portion.

### CROSS-REFERENCE TO RELATED APPLICATIONS

This application is based upon and claims the benefit of priority from Japanese Patent Application No. 2023-011830, filed on Jan. 30, 2023; the entire contents of which are incorporated herein by reference.

### FIELD

Embodiments described herein relate generally to a computer program product, an information processing apparatus, and an information processing method.

### BACKGROUND

A technique of modeling a surrounding environment is used in a system that automatically performs maintenance and inspection of an infrastructure and a system that automatically operating a mobile entity such as an automobile, a drone, or an automatic conveyance vehicle.

An artificial structure such as a road sign board, a signboard, or a building is often constituted by a flat surface or a curved surface. Therefore, the modeling of the surrounding environment is performed, for example, by arranging object models such as a plane, a curved surface, and a cylinder in a virtual space obtained by virtualizing a real space on the basis of three-dimensional point cloud data generated from image data or three-dimensional point cloud data measured by a laser sensor, a radar sensor, or the like. In such modeling of the surrounding environment, a technique for accurately fitting an object model such as a plane, a curved surface, or a cylinder to three-dimensional point cloud data is required.

As a conventional method of fitting a plane model representing a predetermined surface in a recognition object to three-dimensional point cloud data, there is known a method of extracting partial point cloud data representing the recognition object from the three-dimensional point cloud data and calculating a surface having a small distance from the extracted partial point cloud data by a least squares method or principal component analysis.

However, in such a conventional method, in a case of using three-dimensional point cloud data having a relatively large error, the possibility that the position and orientation of the calculated surface deviate from the actual surface is increased. For example, in a case where three-dimensional point cloud data is calculated by correlating pixels of the same object in pieces of image data with each other, or in a case where three-dimensional point cloud data is estimated from one or more pieces of image data using a neural network, an error tends to be larger than that in a case where three-dimensional point cloud data is detected using a laser sensor or a radar sensor. For this reason, in the conventional method, in a case where three-dimensional point cloud data generated from image data is used, the possibility that the position and orientation of the calculated surface deviate from the actual surface is increased.

Moreover, in a case where the recognition target exists outdoors and another object such as a tree planting or a pedestrian exists in front of the recognition target, occlusion in which the other object hides part of the recognition target may occur. In a case where occlusion occurs, in the conventional method, partial point cloud data including a point cloud representing other object is extracted from three-dimensional point cloud data. When the partial point cloud data including the point cloud representing the other object is extracted, the partial point cloud data is dragged by the point cloud representing the other object, and the position and orientation of the calculated surface deviate from the actual surface. For example, a technique of reducing the deviation between the calculated surface and the actual surface by reducing the contribution ratio in the calculation of the surface at each of the points included in the three-dimensional point cloud data as it goes away from the median value, and a technique of reducing the deviation between the calculated surface and the actual surface by calculating the surface by robust estimation are also known. However, even if such a technique is used, in a case where a large number of point clouds of other objects are included, the deviation between the calculated surface and the actual surface is large in the conventional method.

As described above, in the conventional method of fitting the object model to the three-dimensional point cloud data, in a case where a large error is included in the three-dimensional point cloud data or occlusion occurs, the position and orientation of the object model deviate from the actual position and orientation of the recognition target.

### BRIEF DESCRIPTION OF THE DRAWINGS

FIG. 1 is a diagram illustrating a vehicle on which an information processing apparatus is installed and a designated target object;

FIG. 2 is a diagram illustrating a procedure of processing by an information processing apparatus;

FIG. 3 is a diagram illustrating a functional configuration of an information processing apparatus according to a first embodiment;

FIG. 4 is a diagram for explaining a reference coordinate system according to the first embodiment;

FIG. 5 is a diagram for explaining a reference coordinate system according to a second embodiment;

FIG. 6 is a diagram illustrating a functional configuration of an information processing apparatus according to a third embodiment;

FIG. 7 is a diagram for explaining a reference coordinate system according to the third embodiment;

FIG. 8 is a flowchart illustrating a procedure of processing of a generation unit according to a fourth embodiment;

FIG. 9 is a diagram illustrating a first example of a method of calculating an estimated plane;

FIG. 10 is a diagram illustrating a second example of a method of calculating an estimated plane;

FIG. 11 is a diagram illustrating a conversion vector from a model coordinate system to a reference coordinate system;

FIG. 12 is a diagram illustrating a target object model represented by a three-dimensional model;

FIG. 13 is a diagram illustrating a functional configuration of an information processing apparatus according to a sixth embodiment;

FIG. 14 is a diagram illustrating a functional configuration of an information processing apparatus according to a seventh embodiment;

FIG. 15 is a diagram illustrating a size calculation method; and

FIG. 16 is a diagram illustrating an example of a hardware configuration of the information processing apparatus.

### DETAILED DESCRIPTION

According to one embodiment, a computer program product includes a non-transitory computer-readable recording medium on which programmed instructions are recorded. The programmed instructions causing a computer to function as an image acquisition unit, a point cloud acquisition unit, a coordinate system specifying unit, an area detection unit, an extraction unit, a model acquisition unit, a generation unit, and an output unit. The image acquisition unit acquires image data. The point cloud acquisition unit acquires three-dimensional point cloud data including three-dimensional points. Each of the three-dimensional points representing a three-dimensional position of an object included in the image data. The coordinate system specifying unit specifies a reference coordinate system representing a reference of a three-dimensional position. The area detection unit detects, from the image data, a two-dimensional target area in which a designated target object is included. The extraction unit extracts, from the three-dimensional point cloud data, extraction point cloud data representing a three-dimensional position of an object included in the target area. The model acquisition unit acquires a target object model being information obtained by modeling a shape of a first portion. The first portion is at least part of the designated target object. The generation unit generates target object information representing a position and an orientation of the target object model, each corresponding to a case where the target object model is arranged in a three-dimensional space to follow the designated target object. The output unit outputs the target object information. A shape of the first portion of the designated target object is defined, and an orientation of the first portion is defined with respect to at least one of coordinate axes in the reference coordinate system. The generation unit generates the target object information by fitting the target object model to the extraction point cloud data under a condition that an orientation of the target object model matches an orientation defined for the first portion of the designated target object.

Hereinafter, embodiments of the present disclosure will be described with reference to the drawings.

### First Embodiment

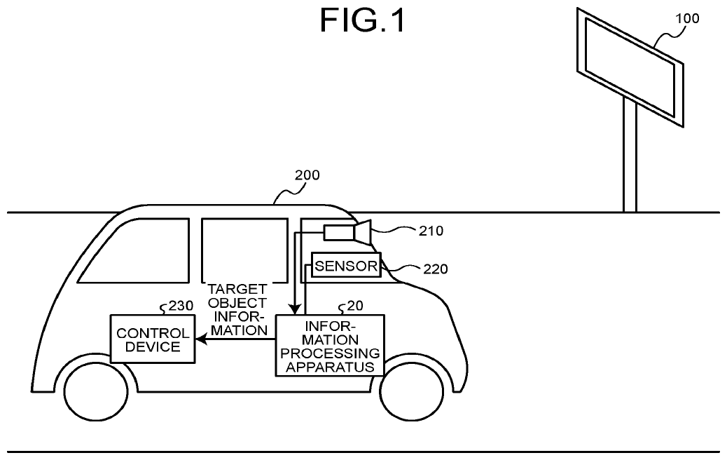

FIG. 1 is a diagram illustrating a vehicle 200 on which an information processing apparatus 20 according to a first embodiment is installed and a designated target object 100.

The information processing apparatus 20 according to the first embodiment generates target object information representing a position and an orientation of a target object model corresponding to a case where the target object model (for example, information representing a plane) representing a shape of a first portion (for example, a main surface on which information such as a road sign is drawn) that is at least part of a designated target object 100 (for example, a road sign board, a signboard, and so forth) existing in a real space is arranged in a three-dimensional space to follow the designated target object 100.

The information processing apparatus 20 is installed in, for example, the vehicle 200 which is an example of a mobile entity. The vehicle 200 includes a camera 210. The camera 210 images an object around the vehicle 200 and generates image data. The vehicle 200 may further include a three-dimensional sensor device 220 such as a laser sensor or a radar sensor. The three-dimensional sensor device 220 generates three-dimensional point cloud data indicating a three-dimensional position of an object around the vehicle 200.

The vehicle 200 further includes a control device 230. The control device 230 controls traveling of the vehicle 200 and assists driving of the vehicle 200 by a driver on the vehicle 200. The control device 230 receives an input from an occupant (for example, a driver) of the vehicle 200 and displays information to the occupant.

The information processing apparatus 20 acquires image data captured by the camera 210. The information processing apparatus 20 may acquire the three-dimensional point cloud data from the three-dimensional sensor device 220. The information processing apparatus 20 generates target object information on the basis of the acquired data and gives the generated target object information to the control device 230 that controls the vehicle 200. The control device 230 controls the vehicle 200 by recognizing the information indicated on the designated target object 100 on the basis of the acquired target object information, and displays information on the designated target object 100 to the occupant of the vehicle 200.

Note that the information processing apparatus 20 maybe provided outside the vehicle 200. Moreover, the information processing apparatus 20 maybe installed in a mobile entity other than the vehicle 200. For example, the information processing apparatus 20 maybe installed in a mobile entity such as a drone or an automatic conveyance vehicle.

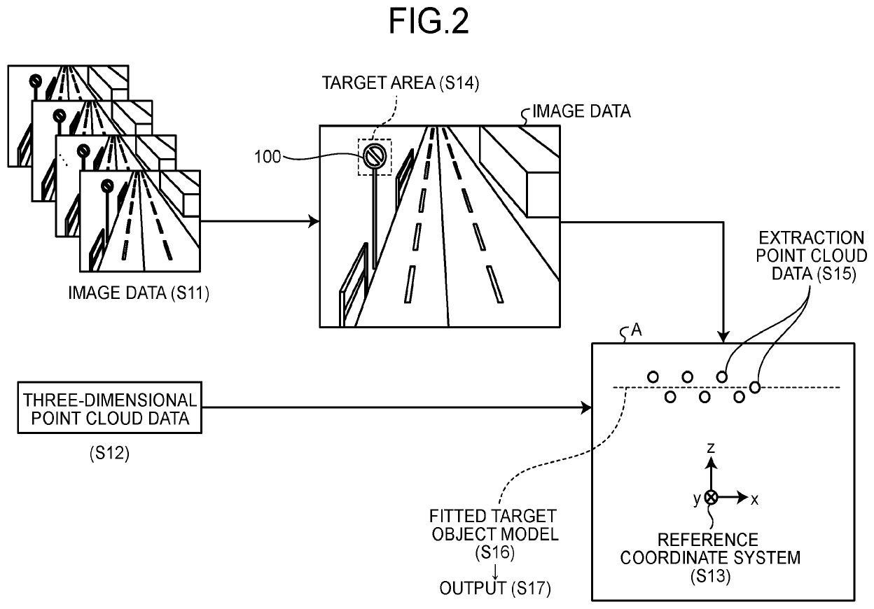

FIG. 2 is a diagram illustrating a procedure of processing by the information processing apparatus 20.

First, the information processing apparatus 20 acquires image data captured by the camera 210 (S11). In addition, the information processing apparatus 20 acquires three-dimensional point cloud data including three-dimensional points, each representing a three-dimensional position of an object included in the image data together with the image data (S12).

Subsequently, the information processing apparatus 20 specifies a reference coordinate system representing the reference of the three-dimensional position of the space in which the designated target object 100 exists (S13).

The reference coordinate system is represented by the origin and three coordinate axes. The three coordinate axes are expressed by, for example, an x-axis, a y-axis, and a z-axis, which are orthogonal to each other. The three-dimensional position in the reference coordinate system is represented by a distance from the origin in each direction of the x-axis, the y-axis, and the z-axis.

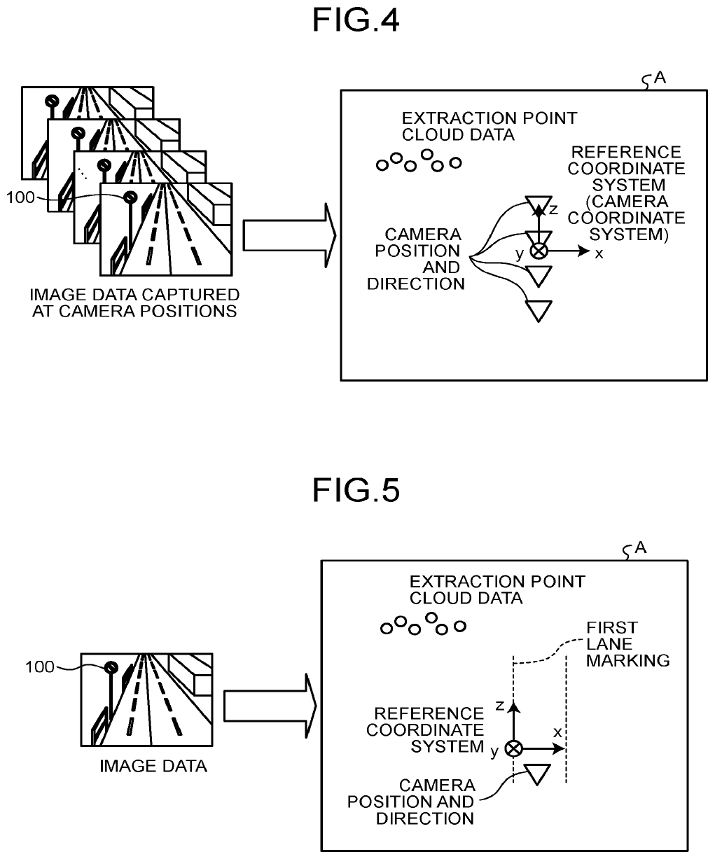

In the first embodiment, the reference coordinate system is a camera coordinate system based on the camera 210 that generates image data. The camera coordinate system will be described later in detail with reference to FIG. 4.

Subsequently, the information processing apparatus 20 detects a two-dimensional target area including the designated target object 100 in the image data (S14).

The designated target object 100 is an object existing in a real space. The shape of the first portion, which is at least part of the designated target object 100, is defined. Moreover, in the designated target object 100, the orientation of the first portion is defined with respect to at least one of coordinate axes in the reference coordinate system. As the orientation of the first portion in the designated target object 100, an orientation with respect to a specific coordinate axis among the three coordinate axes in the reference coordinate may be defined. In addition, the defined coordinate axes of the orientation of the first portion in the designated target object 100 may be unknown. That is, although it is unknown which of the three coordinate axes in the reference coordinate system the first portion in the designated target object 100 is, the orientation with respect to any of the three coordinate axes may be defined.

The shape of the first portion in the designated target object 100 may be, for example, a surface of a rectangle or a cube, or a side surface of a cylinder. In addition, the first portion in the designated target object 100 may be the entire designated target object 100.

The target area may have any shape as long as it is a two-dimensional area including one or more pixels of the image data. In addition, the target area may include objects other than the designated target object 100 as long as at least the designated target object 100 is included. Moreover, the target area may include an area where part of the designated target object 100 is hidden by another object due to occlusion or the like. For example, in a case where the designated target object 100 is a road sign board, the target area may include a tree planting, a pedestrian, etc. existing on the camera 210 side of the road sign board.

Subsequently, the information processing apparatus 20 extracts, from the three-dimensional point cloud data, extraction point cloud data representing the three-dimensional position of the object included in the target area (S15).

Each of the three-dimensional points included in the three-dimensional point cloud data has been correlated with a pixel in the image data. That is, each of the three-dimensional points included in the three-dimensional point cloud data has been correlated with a point (i.e., pixel) in the image data, at which a corresponding one of the three-dimensional points is displayed. Therefore, the information processing apparatus 20 can extract one or more corresponding three-dimensional points included in the three-dimensional point cloud data by specifying a partial area in the image data.

Subsequently, the information processing apparatus 20 generates target object information representing the position and orientation of the target object model, which correspond to a case where the target object model is arranged in the three-dimensional space to follow the designated target object 100 (S16).

The target object model is information obtained by modeling the shape of the first portion in the designated target object 100. For example, the target object model may be an equation representing a shape. In one example, the target object model may be an equation described by using three variables having values of three coordinate axes in the reference coordinate system. In addition, the target object model may be a two-dimensional model or a three-dimensional model, each representing a three-dimensional shape by a model coordinate system different from the reference coordinate system.

In a case of generating the target object information, the information processing apparatus 20 generates the target object information by fitting the target object model to the extraction point cloud data under the condition that the orientation of the target object model matches the orientation defined for the first portion in the designated target object 100. For example, in a case where the designated target object 100 is defined to be parallel or perpendicular to a predetermined direction in the reference coordinate system, the target object model is made parallel or perpendicular to the predetermined direction, and the target object model is fitted to the extraction point cloud data.

Then, the information processing apparatus 20 outputs target object information representing the position and orientation of the target object model fitted to the extraction point cloud data (S17).

Note that an illustration A in FIG. 2 represents the extraction point cloud data and the target object model fitted to the extraction point cloud data, each corresponds to a case where the designated target object 100 is a road sign board, the first portion in the designated target object 100 is a main surface of the road sign plate, and the target object model is information representing a plane. In the illustration A of FIG. 2, the reference coordinate system is a camera coordinate system. The illustration A of FIG. 2 represents the extraction point cloud data and the target object model viewed from above on the y-axis.

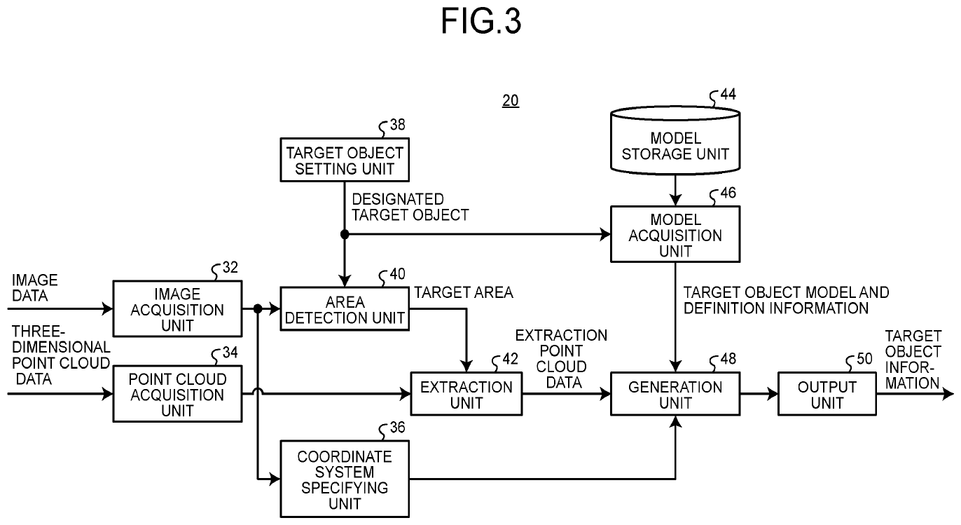

FIG. 3 is a diagram illustrating a functional configuration of the information processing apparatus 20 according to the first embodiment.

The information processing apparatus 20 includes an image acquisition unit 32, a point cloud acquisition unit 34, a coordinate system specifying unit 36, a target object setting unit 38, an area detection unit 40, an extraction unit 42, a model storage unit 44, a model acquisition unit 46, a generation unit 48, and an output unit 50.

The image acquisition unit 32 acquires image data captured by the camera 210. The image data may be a gray image or a color image. The camera 210 may be a monocular camera or a stereo camera.

The point cloud acquisition unit 34 acquires three-dimensional point cloud data including three-dimensional points, each representing a three-dimensional position of an object included in the image data.

The three-dimensional point cloud data is sensor data detected by the three-dimensional sensor device 220. Moreover, the three-dimensional point cloud data may be generated on the basis of one piece of image data captured by the camera 210 or two or more pieces of time-series image data. For example, the three-dimensional point cloud data may be generated by using visual simultaneous localization and mapping (SLAM) on the basis of the image data, or may be generated by using a technique of structure from motion. Moreover, for example, the three-dimensional point cloud data may be generated by using a neural network that estimates the depth of each pixel position of the image data, or may be generated by using another three-dimensional reconstruction technology for three-dimensionalization of an object included in the image data.

The coordinate system specifying unit 36 specifies a reference coordinate system representing the reference of the three-dimensional position of the space in which the designated target object 100 exists. In the first embodiment, the coordinate system specifying unit 36 specifies the camera coordinate system based on the camera 210 that has captured the image data as the reference coordinate system. Note that the camera coordinate system will be described later in detail with reference to FIG. 4.

The target object setting unit 38 sets the designated target object 100. For example, the target object setting unit 38 may set one target object registered in advance as the designated target object 100. Moreover, the target object setting unit 38 may set, as the designated target object 100, a target object selected by the user from among target objects registered in advance.

The area detection unit 40 acquires image data from the image acquisition unit 32. The area detection unit 40 acquires information for identifying the designated target object 100 from the target object setting unit 38. The area detection unit 40 detects a two-dimensional target area including the designated target object 100 in the acquired image data.

The area detection unit 40 may receive an operation from the user and detect an area designated by the user as the target area. The area detection unit 40 may detect a rectangular area identified as the designated target object 100 as the target area by the object recognition technology. Moreover, the area detection unit 40 may detect, as the target area, an area including a pixel identified as the designated target object 100 by semantic segmentation, instance segmentation, or another identification technology.

The extraction unit 42 acquires three-dimensional point cloud data from the point cloud acquisition unit 34. Moreover, the extraction unit 42 acquires the target area from the area detection unit 40. The extraction unit 42 extracts, from the three-dimensional point cloud data, extraction point cloud data representing the three-dimensional position of the object included in the target area. Note that the extraction point cloud data may include a three-dimensional point representing another object that is not the designated target object 100.

The model storage unit 44 stores a pair of the target object model and the definition information. For example, in a case where one target object selected from among target objects registered in advance is set as the designated target object 100, the model storage unit 44 stores a pair of the target object model and the definition information for each target object registered in advance.

The definition information is information representing the orientation of the first portion, whose shape is defined, in the designated target object 100 with respect to at least one of coordinate axes in the reference coordinate system.

For example, it is assumed that the information processing apparatus 20 is installed in the vehicle 200, the road sign board is the designated target object 100, the main surface on which the road sign is drawn is the first portion, and the first portion is provided facing the lane of the road. In this case, for example, the model storage unit 44 stores information representing a plane as a target object model. In this case, for example, the model storage unit 44 stores, as the definition information, information representing that the orientation of the first portion is perpendicular to the coordinate axis parallel to the optical axis of the camera 210 in the reference coordinate system (the camera coordinate system in the first embodiment).

Moreover, for example, it is assumed that the information processing apparatus 20 is installed in the vehicle 200, a signboard provided on a pedestrian passage on a side of a road or a building on a side of the road is the designated target object 100, a main surface on which information is described is the first portion, and the first portion is provided in parallel along a lane of the road. In this case, the model storage unit 44 stores information representing a plane as a target object model. Moreover, in this case, the model storage unit 44 stores, as the definition information, information representing that the orientation of the first portion is parallel to a coordinate axis parallel to the optical axis of the camera 210 in the reference coordinate system (the camera coordinate system in the first embodiment) and is parallel to a coordinate axis parallel to a direction corresponding to the perpendicular direction in the image data.

Moreover, for example, it is assumed that the information processing apparatus 20 is installed in the vehicle 200, a signboard provided on a side wall of a tunnel is the designated target object 100, a main surface on which information is described is the first portion, and the first portion has a shape of part of an inner surface of a hollow cylinder having a central axis parallel to a lane of a road. In this case, for example, the model storage unit 44 stores information representing the inner curved surface of the hollow cylinder as the target object model. Moreover, in this case, the model storage unit 44 stores, as the definition information, information representing that the central axis of the hollow cylinder forming the first portion is parallel to a coordinate axis parallel to the optical axis of the camera 210 in the reference coordinate system (the camera coordinate system in the first embodiment).

The model acquisition unit 46 acquires information for identifying the designated target object 100 from the target object setting unit 38. The model acquisition unit 46 acquires a pair of the target object model and the definition information corresponding to the set designated target object 100 from the model storage unit 44.

The generation unit 48 acquires the extraction point cloud data from the extraction unit 42. The generation unit 48 acquires the reference coordinate system from the coordinate system specifying unit 36. The generation unit 48 acquires a pair of the target object model and the definition information from the model acquisition unit 46.

On the basis of the extraction point cloud data, reference coordinate system, target object model, and definition information, the generation unit 48 generates target object information representing the position and orientation of the target object model, each corresponding to a case where the target object model is arranged in the three-dimensional space to follow the designated target object 100. In this case, the generation unit 48 generates the target object information by fitting the target object model to the extraction point cloud data under the condition that the orientation of the target object model matches the orientation defined for the first portion in the designated target object 100.

Specifically, for example, the generation unit 48 arranges the target object model in the reference coordinate system by adjusting the position and orientation of the target object model so as to minimize the distance to the extraction point cloud data represented by the reference coordinate system under the condition that the orientation of the target object model matches the orientation defined for the first portion in the designated target object 100.

For example, it is assumed that the information processing apparatus 20 is installed in the vehicle 200, the road sign board is the designated target object 100, the main surface on which the road sign is drawn is the first portion, and the first portion is provided to face the lane of the road. Additionally, it is assumed that the target object model is information representing a plane. In this case, the generation unit 48 fixes the orientation of the target object model perpendicularly to the coordinate axis that is parallel to the optical axis of the camera 210 in the reference coordinate system (the camera coordinate system in the first embodiment), and arranges the target object model in the three-dimensional space so as to minimize the distance to the extraction point cloud data. Then, the generation unit 48 generates target object information representing the position and orientation of the target object model arranged such that the distance to the extraction point cloud data is minimized.

For another example, it is assumed that the information processing apparatus 20 is installed in the vehicle 200, a signboard provided on a pedestrian passage on a side of a road or a building on a side of the road is the designated target object 100, a main surface on which information is described is the first portion, and the first portion is provided in parallel along a lane of the road. It is assumed that the target object model is information representing a plane. In this case, the generation unit 48 fixes the orientation of the target object model parallel to the coordinate axis that is parallel to the optical axis of the camera 210 in the reference coordinate system (the camera coordinate system in the first embodiment) and parallel to the coordinate axis parallel to the direction corresponding to the perpendicular direction in the image data, and arranges the target object model in the three-dimensional space so as to minimize the distance to the extraction point cloud data. Then, the generation unit 48 generates target object information representing the position and orientation of the target object model arranged such that the distance to the extraction point cloud data is minimized.

For still another example, it is assumed that the information processing apparatus 20 is installed in the vehicle 200, a signboard provided on a side wall of a tunnel is the designated target object 100, a main surface on which information is described is the first portion, and the first portion has a shape of part of an inner curved surface of a hollow cylinder having a central axis parallel to a lane of a road. It is assumed that the target object model is information representing the inner curved surface of the hollow cylinder. In this case, the generation unit 48 fixes the central axis of the target object model parallel to the coordinate axis that is parallel to the optical axis of the camera 210 in the reference coordinate system (the camera coordinate system in the first embodiment), and arranges the target object model in the three-dimensional space so as to minimize the distance to the extraction point cloud data. Then, the generation unit 48 generates target object information representing the position and orientation of the target object model arranged such that the distance to the extraction point cloud data is minimized.

The output unit 50 acquires target object information from the generation unit 48. The output unit 50 outputs the acquired target object information to the control device 230. Then, the control device 230 controls the vehicle 200 by recognizing the information indicated on the designated target object 100, and displays information on the designated target object 100 generated on the basis of the target object information to the user.

The information processing apparatus 20 as described above generates target object information representing a position and an orientation of a target object model, each corresponding to a case where the target object model (for example, information representing a plane or information representing an inner surface of a hollow cylinder) representing a shape of a first portion (a main surface) that is at least part of a designated target object 100 (for example, a road sign board or a signboard) is arranged in a three-dimensional space to follow the designated target object 100. Especially, in the designated target object 100, the orientation of the first portion is defined with respect to at least one of coordinate axes in the reference coordinate system. Then the information processing apparatus 20 generates the target object information by fitting the target object model to the extraction point cloud data under the condition that the orientation of the target object model matches the orientation defined for the first portion in the designated target object 100.

As a result, according to the information processing apparatus 20, the target object information representing the position and orientation of the target object model, each corresponding to the case of being arranged in the three-dimensional space to follow the designated target object 100 can be generated with high accuracy. For example, according to the information processing apparatus 20, even in a case where a large error is included in the three-dimensional point cloud data, a case where occlusion occurs, or the like, the target object information can be generated with high accuracy.

FIG. 4 is a diagram for explaining a camera coordinate system.

In the first embodiment, the coordinate system specifying unit 36 specifies the camera coordinate system based on the camera 210 that has captured the image data as the reference coordinate system. More specifically, in the reference coordinate system of the first embodiment, the origin is the three-dimensional position of the camera 210, the x-axis represents the direction corresponding to the horizontal direction in the image data captured by the camera 210, the y-axis represents the direction corresponding to the perpendicular direction in the image data captured by the camera 210, and the z-axis represents the direction parallel to the optical axis of the camera 210. The x-axis, the y-axis, and the z-axis may be assigned in an optional manner as long as any one of the direction corresponding to the horizontal direction in the image data, the direction corresponding to the perpendicular direction in the image data, and the direction parallel to the optical axis of the camera 210 is assigned without overlapping.

In a case where the image acquisition unit 32 acquires pieces of image data captured in time series, the coordinate system specifying unit 36 specifies the camera coordinate system of an optional one of pieces of the image data as the reference coordinate system. The coordinate system specifying unit 36 acquires image data in which the size of the included designated target object 100 is larger than the reference size, image data in which the entire designated target object 100 is included, image data captured when the camera 210 is linearly moving, randomly selected image data, or the like, and acquires the reference coordinate system on the basis of the acquired image data.

An illustration A in FIG. 4 represents a relationship among the camera position, the extraction point cloud data, and the reference coordinate system in a case where the vehicle 200 on which the information processing apparatus 20 is installed passes near the road sign board which is the designated target object 100. The extraction point cloud data in the illustration A of FIG. 4 represents a three-dimensional point viewed from above on the y-axis. The coordinate system specifying unit 36 specifies the reference coordinate system on the basis of an optional one of pieces of image data continuously captured by the moving camera 210.

In a case where the information processing apparatus 20 is installed in the vehicle 200, the optical axis of the camera 210 is often parallel to the traveling direction of the vehicle 200. In many cases, an artifact provided near a road, such as a road sign board or a signboard, is installed such that a planar portion is perpendicular or parallel to the traveling direction of the vehicle 200. Therefore, in a case where the camera coordinate system is set as the reference coordinate system and the artifact provided in the vicinity of the road is set as the designated target object 100, the information processing apparatus 20 can easily match the orientation of the target object model with the orientation defined for the first portion of the designated target object 100.

As described above, according to the information processing apparatus 20, by appropriately selecting the designated target object 100 and the reference coordinate system, the orientation of the target object model can be easily matched with the orientation defined for the first portion in the designated target object 100, and as a result, the target object information can be generated with a small amount of calculation.

### Second Embodiment

Next, an information processing apparatus 20 according to a second embodiment will be described.

The information processing apparatus 20 according to the second embodiment has substantially the same configuration and function as those of the information processing apparatus 20 according to the first embodiment. Hereinafter, in describing the information processing apparatus 20 according to the second embodiment, differences will be described, and components having substantially the same functions as those of the first embodiment will be denoted by the same reference numerals, and a detailed description thereof will be omitted. The same applies to the third and subsequent embodiments.

FIG. 5 is a diagram for describing a coordinate system in which one of three coordinate axes is parallel to a lane marking on a road.

In the second embodiment, the information processing apparatus 20 is installed in the vehicle 200. In the second embodiment, the information processing apparatus 20 sets an artifact provided around a road as a designated target object 100.

In the second embodiment, the coordinate system specifying unit 36 specifies, as a reference coordinate system, a coordinate system in which one of the three coordinate axes is parallel to the lane marking on the road. More specifically, in the reference coordinate system of the second embodiment, the origin is an optional point on a first lane marking which is an optional lane marking on the road, an x-axis represents a direction parallel to a road plane and perpendicular to the first lane marking, a y-axis represents a direction perpendicular to the road plane, and a z-axis represents a direction parallel to the first lane marking.

The origin may be any three-dimensional position. In addition, the x-axis, the y-axis, and the z-axis may be assigned in any manner as long as any one of a direction parallel to the road plane and perpendicular to the first lane marking, a direction perpendicular to the road plane, and a direction parallel to the first lane marking is assigned without overlapping.

The lane marking is a line drawn on a road for guiding the vehicle 200 to travel. For example, the lane marking is a center line drawn substantially at the center of the road, an edge marking that defines the outside of the road, and so forth.

In the second embodiment, the coordinate system specifying unit 36 specifies such a reference coordinate system on the basis of, for example, image data or map information acquired in advance. For example, the coordinate system specifying unit 36 acquires the area of the lane marking from the image data using an identification technology such as semantic segmentation or instance segmentation. Then, the coordinate system specifying unit 36 maps the lane marking included in the acquired area in the three-dimensional space, and fits straight line data, curve data, or the like to the lane marking mapped in the three-dimensional space, thereby specifying the reference coordinate system.

An illustration A in FIG. 5 represents a relationship among the camera position, the extraction point cloud data, and the reference coordinate system in a case where the vehicle 200 passes near the road sign board which is the designated target object 100. The extraction point cloud data in A of FIG. 5 represents a three-dimensional point viewed from above on the y-axis.

In many cases, an artifact provided near a road, such as a road sign board or a signboard, is installed such that a planar portion is perpendicular or parallel to the direction of the lane marking on the road. Therefore, in a case where the coordinate system in which one of the three coordinate axes is parallel to the lane marking on the road is set as the reference coordinate system and the artifact provided in the vicinity of the road is set as the designated target object 100, the information processing apparatus 20 can easily match the orientation of the target object model with the orientation defined for the first portion of the designated target object 100. Therefore, according to the information processing apparatus 20 according to the second embodiment, the target object information can be generated with a small amount of calculation.

### Third Embodiment

Next, an information processing apparatus 20 according to a third embodiment will be described.

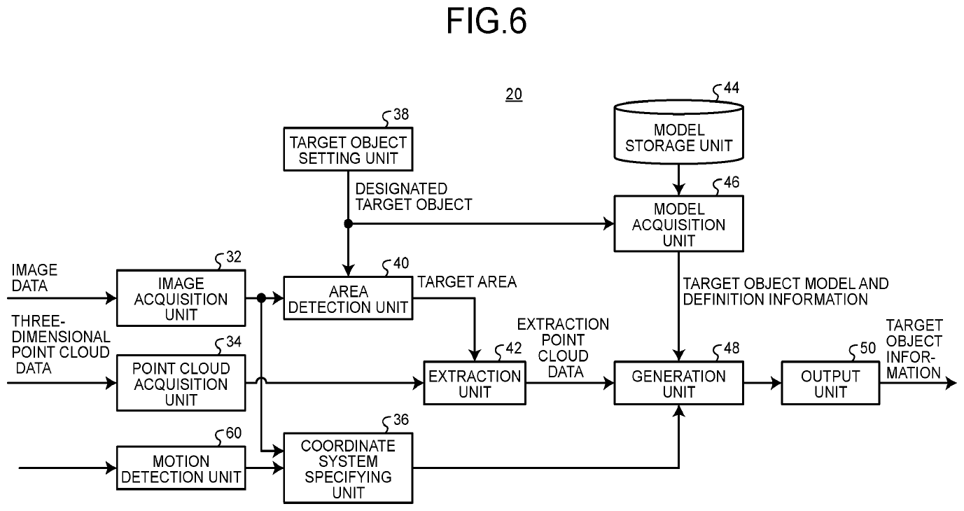

FIG. 6 is a diagram illustrating a functional configuration of the information processing apparatus 20 according to the third embodiment.

In the third embodiment, the information processing apparatus 20 is installed in the vehicle 200. In the third embodiment, the information processing apparatus 20 sets an artifact provided around a road as a designated target object 100.

The information processing apparatus 20 further includes a motion detection unit 60 in addition to the configuration of the information processing apparatus 20 according to the first embodiment.

The motion detection unit 60 detects the motion of the camera 210. More specifically, the motion detection unit 60 detects parameters representing the time-series translational movement and rotational movement of the camera 210. For example, the motion detection unit 60 may detect the motion of the camera 210 by visual SLAM or may detect the motion of the camera 210 by a technique of structure from motion on the basis of two or more pieces of image data captured in time series by the camera 210.

Moreover, for example, the motion detection unit 60 may detect the motion of the camera 210 using a neural network that estimates the motion of the camera 210 from the image data. Moreover, the motion detection unit 60 may detect the motion of the camera 210 on the basis of sensor data acquired by a sensor other than the camera 210, such as a global positioning system (GPS), an acceleration sensor, and an angular velocity sensor, or may detect the motion of the camera 210 by combining these sensor data.

In the third embodiment, the coordinate system specifying unit 36 acquires the motion of the camera 210 detected by the motion detection unit 60. The coordinate system specifying unit 36 calculates the moving direction of the camera 210 on the basis of the movement of the camera 210. Then, the coordinate system specifying unit 36 specifies the reference coordinate system on the basis of the calculated moving direction of the camera 210.

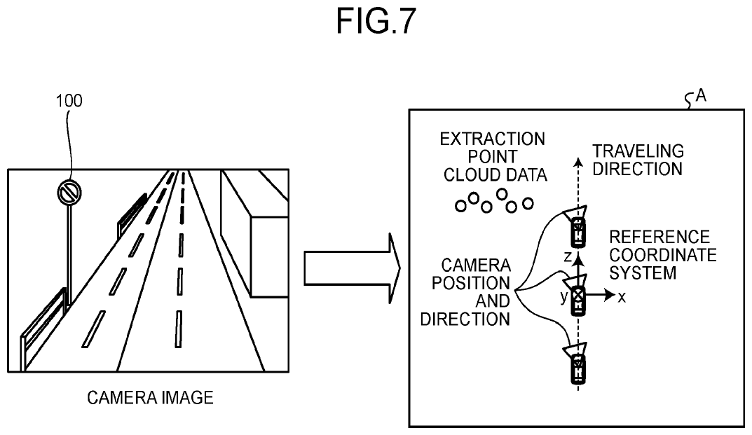

FIG. 7 is a diagram for describing a coordinate system in which one of three coordinate axes is parallel to the moving direction of the camera 210.

In the third embodiment, the coordinate system specifying unit 36 specifies, as a reference coordinate system, a coordinate system in which one of the three coordinate axes is parallel to the moving direction of the camera 210. More specifically, in the reference coordinate system of the third embodiment, the origin is the three-dimensional position of the camera 210, the x-axis represents the direction perpendicular to the moving direction of the camera 210 and parallel to the road, the y-axis represents the direction perpendicular to the moving direction of the camera 210 and perpendicular to the road, and the z-axis represents the direction parallel to the moving direction of the camera 210.

The x-axis, the y-axis, and the z-axis may be assigned in any manner as long as any one of a direction perpendicular to the moving direction of the camera 210 and parallel to the road, a direction perpendicular to the moving direction of the camera 210 and perpendicular to the road, and a direction parallel to the moving direction of the camera 210 is assigned without overlapping.

The moving direction of the camera 210 is a direction of a change in the three-dimensional position of any portion of the camera 210.

An illustration A in FIG. 7 represents a relationship between the camera position and the imaging direction, the extraction point cloud data, the moving direction of the camera 210, and the reference coordinate system in a case where the vehicle 200 on which the information processing apparatus 20 is installed passes near the road sign board which is the designated target object 100. The extraction point cloud data in the illustration A of FIG. 7 represents a three-dimensional point viewed from above on the y-axis.

After the user purchases the vehicle 200, a drive recorder with a camera 210 may be attached to the vehicle 200. In such a case, the direction of the optical axis of the camera 210 may deviate from the traveling direction of the vehicle 200. If the direction of the optical axis of the camera 210 deviates from the traveling direction of the vehicle 200, the optical axis of the camera 210 is not in a perpendicular relationship to the main surface of the road sign board. Moreover, in such a case, the optical axis of the camera 210 is not in a parallel relationship with the pedestrian passage on the side of the road or the signboard provided in the building on the side of the road, or the central axis of the cylinder forming the tunnel. Therefore, when the artifact provided around the road is set as the designated target object 100, the information processing apparatus 20 cannot facilitate the processing of matching the orientation of the target object model with the orientation defined for the first portion of the designated target object 100 even if the camera coordinate system is specified as the reference coordinate system.

In contrast, the information processing apparatus 20 according to the third embodiment sets a coordinate system in which one of the three coordinate axes is parallel to the moving direction of the camera 210 as a reference coordinate system.

By installing the information processing apparatus 20 in the vehicle 200, the moving direction of the camera 210 is oriented to be parallel to the traveling direction of the vehicle 200. In many cases, an artifact provided near a road, such as a road sign board or a signboard, is installed such that a planar portion is perpendicular or parallel to the traveling direction of the vehicle 200. Therefore, in a case where the coordinate system in which one of the three coordinate axes is parallel to the moving direction of the camera 210 is set as the reference coordinate system and the artifact provided in the vicinity of the road is set as the designated target object 100, the information processing apparatus 20 can easily match the orientation of the target object model with the orientation defined for the first portion of the designated target object 100. As a result, according to the information processing apparatus 20 according to the third embodiment, the target object information can be generated with a small amount of calculation.

### Fourth Embodiment

Next, an information processing apparatus 20 according to a fourth embodiment will be described.

In the fourth embodiment, the first portion of the designated target object 100 is a plane. Moreover, in the fourth embodiment, the target object model is a plane equation.

In the fourth embodiment, the reference coordinate system may be the camera coordinate system used in the first embodiment, the coordinate system in which one of the three coordinate axes used in the second embodiment is parallel to the lane marking on the road, or the coordinate system in which one of the three coordinate axes used in the third embodiment is parallel to the moving direction of the camera 210. Note that the orientation of the first portion of the designated target object 100 is defined to be parallel to any one of the three coordinate axes in the reference coordinate system. For example, in a case where the information processing apparatus 20 is installed in the vehicle 200 and the designated target object 100 is an artifact provided around a road, such as a road sign board or a signboard, the first portion of the designated target object 100 is defined as an orientation parallel or orthogonal to the optical axis direction of the camera 210, the lane marking on the road, or the moving direction of the camera 210.

In the fourth embodiment, the generation unit 48 constrains the plane represented by the equation in parallel with the coordinate axis parallel to the first portion in the reference coordinate system, and calculates the estimated plane that minimizes the distance to each of the three-dimensional points included in the extraction point cloud data. As a result, the generation unit 48 can generate an estimated plane having the smallest error with respect to the extraction point cloud data. Then, the generation unit 48 outputs target object information representing the position and orientation of the estimated plane.

Note that the first portion of the designated target object 100 may be a curved surface. For example, it is assumed that the designated target object 100 is a signboard provided on a side wall of a tunnel, and the first portion in the designated target object 100 has a shape of part of an inner curved surface of a hollow cylinder having a central axis parallel to a lane of a road. In this case, the generation unit 48 may constrain the central axis of the hollow cylinder represented by the equation in parallel with the coordinate axis parallel to the first portion in the reference coordinate system, and calculate the estimated curved surface that minimizes the distance to each of the three-dimensional points included in the extraction point cloud data.

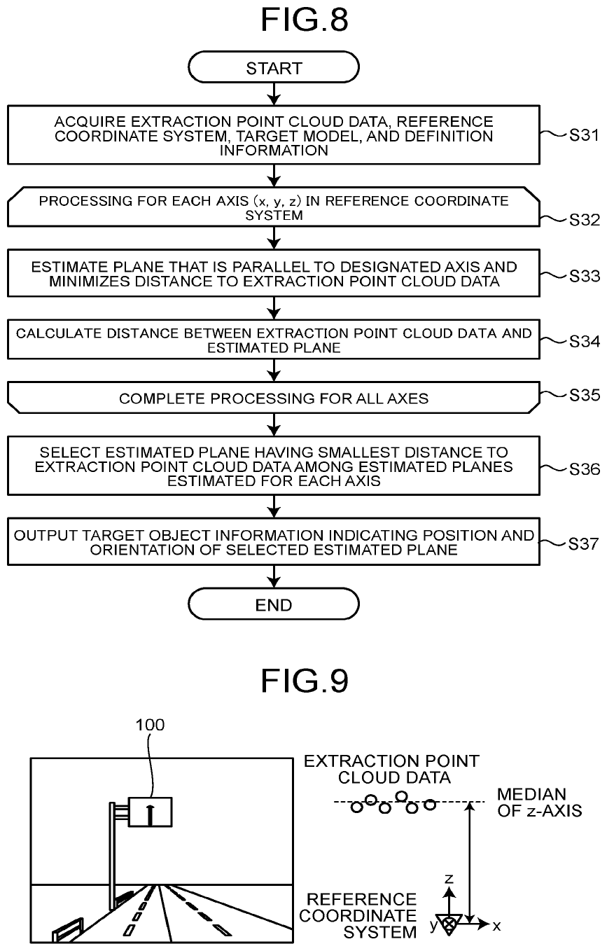

FIG. 8 is a flowchart illustrating a procedure of processing of the generation unit 48 according to the fourth embodiment;

In a case where it is unknown which coordinate axis among the three coordinate axes the first portion of the designated target object 100 is parallel to, the generation unit 48 executes the processing in the flowchart illustrated in FIG. 8, for example.

First, in S31, the generation unit 48 acquires the extraction point cloud data, the reference coordinate system, the target object model, and the definition information. In this case, the definition information indicates that the plane represented by the target object model is parallel to any of the coordinate axis.

Subsequently, the generation unit 48 executes loop processing between S32 and S35. In the loop processing, the generation unit 48 executes the processing of S33 and S34 for each of the three coordinate axes (x-axis, y-axis, and z-axis).

In S33, the generation unit 48 constrains the plane represented by the equation in parallel with the coordinate axis of the target, and estimates the estimated plane that minimizes the distance to each of the three-dimensional points included in the extraction point cloud data using the least squares method or the like. Subsequently, in S34, the generation unit 48 calculates a distance between the extraction point cloud data and the estimated plane.

When the processing of S33 and S34 is completed for all the three coordinate axes (S35), the generation unit 48 exits the loop processing and advances the processing to S36.

In S36, the generation unit 48 selects an estimated plane having the smallest distance to the extraction point cloud data among the three estimated planes estimated for the three coordinate axes. Then, in S37, the generation unit 48 outputs target object information representing the position and orientation of the selected estimated plane.

As described above, in a case where it is unknown which coordinate axis among the three coordinate axes the first portion of the designated target object 100 is parallel to, the generation unit 48 generates the estimated plane for each of the three coordinate axes. Then, the generation unit 48 selects an estimated plane having the smallest distance to the extraction point cloud data from among the three estimated planes generated for the three coordinate axes, and outputs target object information representing the position and orientation of the selected estimated plane. As a result, even if it is unknown which one of the three coordinate axes the first portion of the designated target object 100 is parallel to, the generation unit 48 can fit the target object model to the first portion of the designated target object 100.

Even when the first portion of the designated target object 100 is a curved surface, the generation unit 48 can estimate the estimated curved surface by the procedure illustrated in the flowchart in FIG. 8. For example, it is assumed that the designated target object 100 is a signboard provided on a side wall of a tunnel, and the first portion in the designated target object 100 has a shape of part of an inner curved surface of a hollow cylinder having a central axis parallel to a lane of a road. In this case, the generation unit 48 generates an estimated curved surface for each of the three coordinate axes. Then, the generation unit 48 may select an estimated curved surface having the smallest distance to the extraction point cloud data among the three estimated curved surfaces generated for the three coordinate axes, and output target object information representing the position and orientation of the selected estimated curved surface.

FIG. 9 is a diagram illustrating an example of the method of calculating the estimated plane in a case where the first portion of the designated target object 100, which is a plane, is perpendicular to the optical axis of the camera 210, the lane marking on the road, or the moving direction of the camera 210.

In a case where the first portion of the designated target object 100, which is a plane, is perpendicular to the optical axis of the camera 210, the lane marking on the road, or the moving direction of the camera 210, the first portion of the designated target object 100 is parallel to two coordinate axes different from the optical axis that is parallel to the optical axis of the camera 210, the lane marking on the road, or the moving direction of the camera 210. That is, in a case where a direction parallel to the optical axis of the camera 210, the lane marking on the road, or the moving direction of the camera 210 is the z-axis, the first portion in the designated target object 100 is parallel to the x-axis and the y-axis.

In such a case, in the equation representing the plane, the variable (x) representing the distance in the direction of the x-axis from the origin and the variable (y) representing the distance in the direction of the y-axis from the origin are each multiplied by the coefficient being zero. Therefore, in such a case, the equation representing the plane is expressed as z=C₁. C₁ is a constant.

Therefore, in such a case, the generation unit 48 calculates the median of the positions in the z direction of the three-dimensional points included in the extraction point cloud data, and calculates the estimated plane in which the calculated median is the constant (C₁). As a result, the generation unit 48 can calculate the estimated plane by very simple calculation. Note that the generation unit 48 may calculate an estimated plane in which the average value is the constant (C₁) instead of the median value.

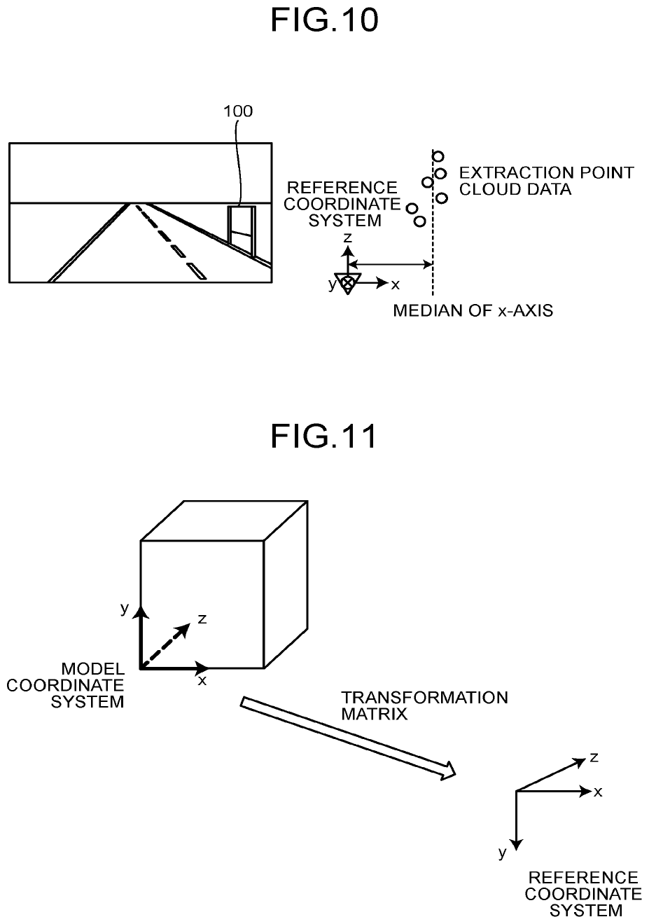

FIG. 10 is a diagram illustrating an example of the method of calculating the estimated plane in a case where the first portion of the designated target object 100, which is a plane, is parallel to the optical axis of the camera 210, the lane marking on the road, or the moving direction of the camera 210, and perpendicular to the road.

In a case where the first portion of the designated target object 100, which is a plane, is parallel to the optical axis of the camera 210, the lane marking on the road, or the moving direction of the camera 210, and perpendicular to the road, the first portion of the designated target object 100 is parallel to a coordinate axis that is parallel to the optical axis of the camera 210, the lane marking on the road, or the moving direction of the camera 210, and parallel to a coordinate axis that is perpendicular to the road. That is, if a coordinate axis parallel to the optical axis of the camera 210, the lane marking on the road, or the moving direction of the camera 210 is defined as the z-axis, and a coordinate axis parallel to the direction perpendicular to the road is defined as the y-axis, the first portion of the designated target object 100 is parallel to the z-axis and the y-axis.

In such a case, in the equation representing the plane, the variable (z) representing the distance in the direction of the z-axis from the origin and the variable (y) representing the distance in the direction of the y-axis from the origin are each multiplied by the coefficient being zero. Therefore, in such a case, the equation representing the plane is expressed as x=C₂. C₂ is a constant.

Therefore, in such a case, the generation unit 48 calculates the median of the positions in the x direction of the three-dimensional points included in the extraction point cloud data, and calculates the estimated plane in which the calculated median is the constant (C₂). As a result, the generation unit 48 can calculate the estimated plane by very simple calculation. Note that the generation unit 48 may calculate an estimated plane in which the average value is the constant (C₂) instead of the median value.

By calculating the estimated plane as described above, the generation unit 48 can accurately calculate the estimated plane even if an error is included in the extraction point cloud data or a three-dimensional point of another object is included in the extraction point cloud data due to occlusion. For example, the generation unit 48 can accurately calculate the estimated plane even if the three-dimensional point cloud data is generated on the basis of the image data.

For example, even in a case where a tree planting exists in front of the designated target object 100 illustrated in FIG. 9 or a pedestrian exists in front of the designated target object 100 illustrated in FIG. 10, the generation unit 48 can accurately calculate the estimated plane as long as at least more than half of the three-dimensional points of the designated target object 100 are included in the extraction point cloud data.

### Fifth Embodiment

Next, an information processing apparatus 20 according to a fifth embodiment will be described.

FIG. 11 is a diagram illustrating a conversion vector from a model coordinate system to a reference coordinate system. In the fifth embodiment, the first portion of the designated target object 100 has a three-dimensional shape. In addition, in the fifth embodiment, the target object model is a three-dimensional model representing the three-dimensional shape of the first portion represented by a model coordinate system different from the reference coordinate system.

The generation unit 48 according to the fifth embodiment calculates a transformation vector that minimizes the distance between each of the three-dimensional points included in the extraction point cloud data and the target object model under the condition that the orientation of the target object model matches the orientation defined for the first portion in the designated target object 100. The transformation vector is a vector that performs coordinate transformation from the model coordinate system to the reference coordinate system.

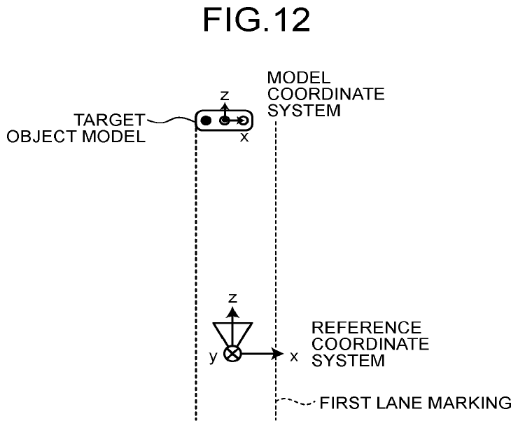

FIG. 12 is a diagram illustrating a target object model represented by a three-dimensional model. In the fifth embodiment, the designated target object 100 is an object having a three-dimensional shape whose shape is defined. In the fifth embodiment, the orientation of the designated target object 100 with respect to at least one of coordinate axes in the reference coordinate system is defined.

For example, in the fifth embodiment, the designated target object 100 is a traffic light that permits or stops traveling of the vehicle 200. The traffic light is installed such that the light emission directions of the signal lights are parallel to the traveling direction of the vehicle 200. Therefore, in the designated target object 100 that is a traffic light, the light emission directions of the signal lights are defined to be parallel to the optical axis direction of the camera 210, the lane marking on the road, or the coordinate axis parallel to the moving direction of the camera 210.

With respect to the designated target object 100, it is assumed that the light emission directions of the signal lights are parallel to the z-axis in the reference coordinate system. In this case, in the transformation matrix for coordinate-transforming from the model coordinate system to the reference coordinate system, the rotation angle about the y-axis can be set to 0. Therefore, the generation unit 48 according to the fifth embodiment can constrain some components in the transformation matrix to a predetermined value and fit the target object model to the extraction point cloud data. As a result, the generation unit 48 according to the fifth embodiment can easily and accurately fit the target object model that is the three-dimensional model.

### Sixth Embodiment

Next, an information processing apparatus 20 according to a sixth embodiment will be described.

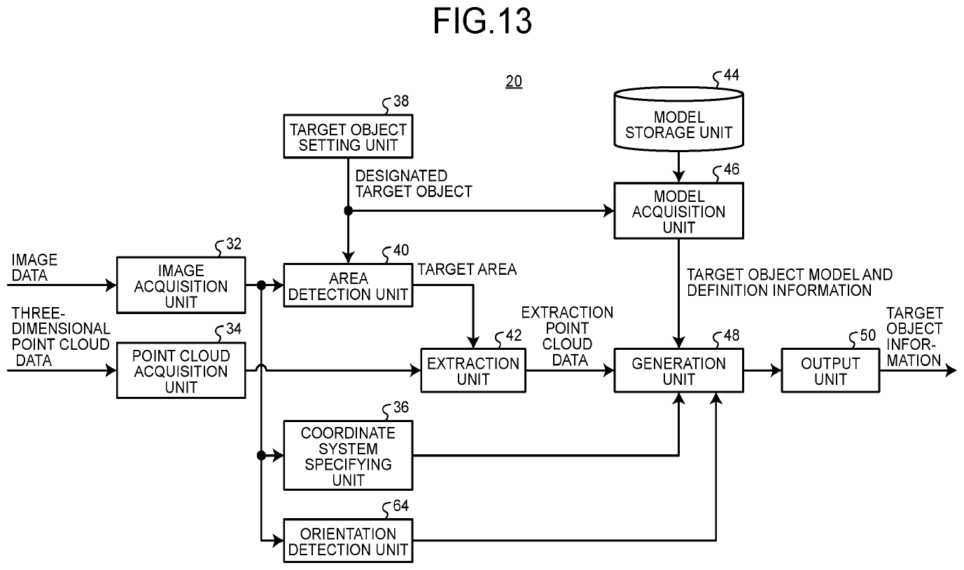

FIG. 13 is a diagram illustrating a functional configuration of the information processing apparatus 20 according to the sixth embodiment. In the sixth embodiment, the orientation of the designated target object 100 with respect to the reference coordinate system is defined. In the sixth embodiment, the information processing apparatus 20 further includes an orientation detection unit 64 in addition to the configuration of the information processing apparatus 20 according to the first embodiment.

The orientation detection unit 64 detects the orientation of the first portion in the designated target object 100. The orientation detection unit 64 detects the orientation of the designated target object 100 by an object detection technique on the basis of the image data. Moreover, the orientation detection unit 64 may detect the orientation of the designated target object 100 on the basis of information input by operation by the user.

In the sixth embodiment, the generation unit 48 further acquires the orientation detected by the orientation detection unit 64. In the sixth embodiment, the generation unit 48 generates the target object information by fitting the target object model to the extraction point cloud data under the condition that the orientation of the target object model matches the orientation of the first portion in the designated target object 100 detected. As a result, the generation unit 48 can calculate the distance between the extraction point cloud data and the target object model in one process without calculating the distance between the extraction point cloud data and the target object model for all the three coordinate axes as in the flowchart illustrated in FIG. 8, for example. As a result, the information processing apparatus 20 according to the sixth embodiment can generate target object information with high accuracy by simple processing.

### Seventh Embodiment

Next, an information processing apparatus 20 according to a seventh embodiment will be described.

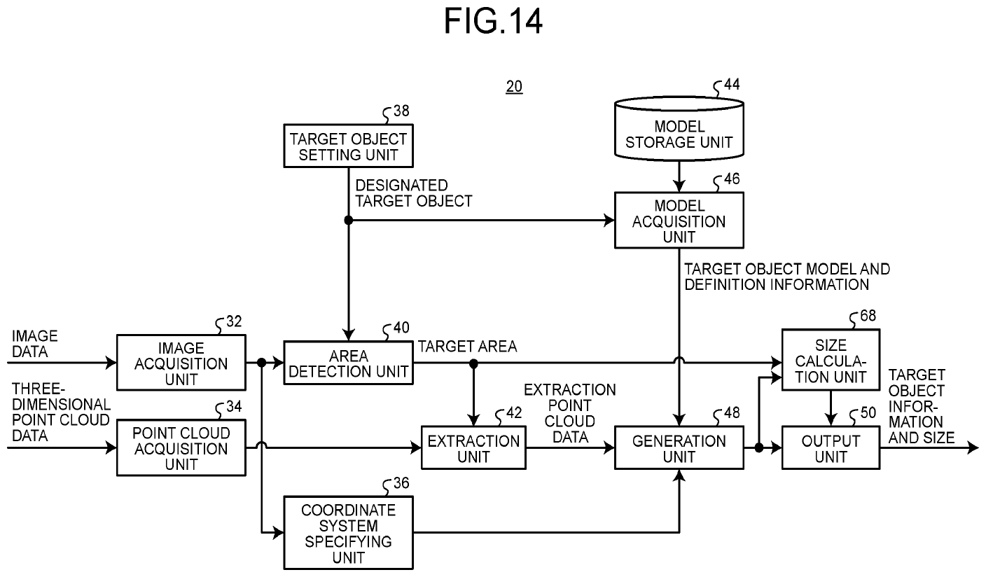

FIG. 14 is a diagram illustrating a functional configuration of an information processing apparatus 20 according to the seventh embodiment. In the seventh embodiment, the information processing apparatus 20 further includes a size calculation unit 68 in addition to the configuration of the information processing apparatus 20 according to the first embodiment.

The size calculation unit 68 acquires the target area detected by the area detection unit 40 and the target object information generated by the generation unit 48. The size calculation unit 68 calculates the size of the designated target object 100 on the basis of the target area and the target object information. The size of the designated target object 100 is, for example, at least one value of the height (H) of the designated target object 100, the width (W) or the depth of the designated target object 100.

The output unit 50 acquires the size from the size calculation unit 68. The output unit 50 outputs the size together with the target object information.

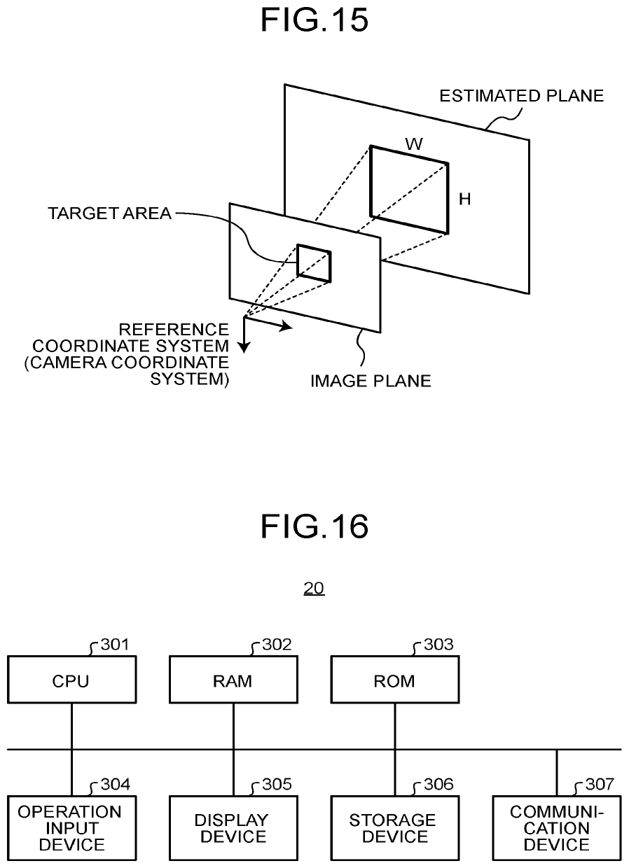

FIG. 15 is a diagram illustrating a size calculation method.

For example, when the target object model is information representing a plane, the size calculation unit 68 projects the target area in the image plane represented by the image data onto the estimated plane. Then, the size calculation unit 68 calculates the size by measuring the height (H) and the width (W) in the target area projected on the estimated plane. In addition, even when the target object model is a curved surface, the size calculation unit 68 calculates the size by measuring the distance or the Euclidean distance of the height (H) and the width (W) on the curved surface in the target area projected on the estimated curved surface.

According to the information processing apparatus 20 according to the seventh embodiment, it is possible to cause the control device 230 to control the vehicle 200 by recognizing the information indicated by the designated target object 100 on the basis of the target object information and the size, and to display the information regarding the designated target object 100 to the occupant of the vehicle 200.

### Hardware Configuration of Information Processing Apparatus

FIG. 16 is a diagram illustrating an example of a hardware configuration of the information processing apparatus 20 according to each embodiment.

The information processing apparatus 20 is realized by a computer having a hardware configuration as illustrated in FIG. 16, for example. The information processing apparatus 20 includes a central processing unit (CPU) 301, a random access memory (RAM) 302, a read only memory (ROM) 303, an operation input device 304, a display device 305, a storage device 306, and a communication device 307. These units are connected by a bus.

The CPU 301 is a processor that executes arithmetic processing, control processing, and so forth according to a computer program. The CPU 301 uses a predetermined area of the RAM 302 as a work area, and executes various processing in cooperation with programs stored in the ROM 303, the storage device 306, and so forth.

The RAM 302 is a memory such as a synchronous dynamic random access memory (SDRAM). The RAM 302 functions as a work area of the CPU 301. The

ROM 303 is a memory that stores programs and various types of information in a non-rewritable manner.

The operation input device 304 is an input device such as a mouse and a keyboard. The operation input device 304 receives information operationally input from the user as an instruction signal, and outputs the instruction signal to the CPU 301.

The display device 305 is a display device such as a liquid crystal display (LCD). The display device 305 displays various types of information on the basis of a display signal from the CPU 301.

The storage device 306 is a device that writes and reads data in and from a semiconductor storage medium such as a flash memory, a magnetically or optically recordable storage medium, or the like. The storage device 306 writes and reads data to and from the storage medium under the control of the CPU 301. The communication device 307 communicates with an external device via a network in accordance with control from the CPU 301.

The program executed by the computer may have a module configuration including an image acquisition module, a point cloud acquisition module, a coordinate system specifying module, a target object setting module, an area detection module, an extraction module, a model acquisition module, a generation module, and an output module. The program may further include a motion detection module, an orientation detection module, and a size calculation module.

The above-described computer program is developed and executed on the RAM 302 by the CPU 301 (processor), thereby causing the computer to function as the image acquisition unit 32, the point cloud acquisition unit 34, the coordinate system specifying unit 36, the target object setting unit 38, the area detection unit 40, the extraction unit 42, the model acquisition unit 46, the generation unit 48, and the output unit 50. Moreover, this program may cause the computer to function as the motion detection unit 60, the orientation detection unit 64, and the size calculation unit 68. Some or all of the image acquisition unit 32, the point cloud acquisition unit 34, the coordinate system specifying unit 36, the target object setting unit 38, the area detection unit 40, the extraction unit 42, the model acquisition unit 46, the generation unit 48, and the output unit 50 may be realized by a hardware circuit.

In addition, the program executed by the computer may be provided, as a computer program product, by being recorded on a non-transitory computer-readable recording medium such as a CD-ROM, a flexible disk, a CD-R, or a digital versatile disk (DVD) as a file in a format that can be installed or executed in the computer.

Moreover, the program may be stored on a computer connected to a network such as the Internet, and may be provided by being downloaded via the network. Moreover, the program may be provided or distributed via a network such as the Internet. Moreover, the program executed by the information processing apparatus 20 maybe provided by being incorporated in the ROM 303 or the like in advance.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplement

Note that the above embodiments can be summarized in the following technical schemes.

### Technical Scheme 1

A computer program product comprising a non-transitory computer-readable recording medium on which programmed instructions are recorded, the programmed instructions causing a computer to function as:
an image acquisition unit to acquire image data;
a point cloud acquisition unit to acquire three-dimensional point cloud data including three-dimensional points, each of the three-dimensional points representing a three-dimensional position of an object included in the image data;
a coordinate system specifying unit to specify a reference coordinate system representing a reference of a three-dimensional position;
an area detection unit to detect, from the image data, a two-dimensional target area in which a designated target object is included;
an extraction unit to extract, from the three-dimensional point cloud data, extraction point cloud data representing a three-dimensional position of an object included in the target area;
a model acquisition unit to acquire a target object model being information obtained by modeling a shape of a first portion, the first portion being at least part of the designated target object;
a generation unit to generate target object information representing a position and an orientation of the target object model, each corresponding to a case where the target object model is arranged in a three-dimensional space to follow the designated target object; and
an output unit to output the target object information, wherein
a shape of the first portion of the designated target object is defined, and an orientation of the first portion is defined with respect to at least one of coordinate axes in the reference coordinate system, and
the generation unit generates the target object information by fitting the target object model to the extraction point cloud data under a condition that an orientation of the target object model matches an orientation defined for the first portion of the designated target object.

### Technical Scheme 2

The computer program product according to the technical scheme 1, wherein
the image data is generated by a camera installed in a mobile entity, and
the reference coordinate system has three coordinate axes, one of which is parallel to an optical axis of the camera.

### Technical Scheme 3

The computer program product according to the technical scheme 1, wherein
the image data is generated by a camera installed in a mobile entity traveling on a road, and
the reference coordinate system has three coordinate axes, one of which is parallel to a lane marking on the road.

### Technical Scheme 4

The computer program product according to the technical scheme 1, wherein
the image data is generated by a camera installed in a mobile entity, and
the reference coordinate system has three coordinate axes, one of which is parallel to a moving direction of the camera.

### Technical Scheme 5

The computer program product according to the technical scheme 4, wherein the moving direction is calculated on the basis of a movement of the camera.

### Technical Scheme 6

The computer program product according to any one of the technical schemes 1 to 5, wherein the first portion of the designated target object is a plane and is parallel to one or two of three coordinate axes in the reference coordinate system.

### Technical Scheme 7

The computer program product according to the technical scheme 6, wherein the target object model is an equation of the plane.

### Technical Scheme 8

The computer program product according to the technical scheme 7, wherein the generation unit
constrains the plane represented by the equation in parallel with the coordinate axis being parallel to the first portion in the reference coordinate system,
generates an estimated plane minimizing a distance to each of the three-dimensional points included in the extraction point cloud data, and
generates the target object information representing a position and an orientation of the estimated plane.

### Technical Scheme 9

The computer program product according to any one of the technical schemes 1 to 5, wherein
the first portion of the designated target object has a shape of part of an inner curved surface of a hollow cylinder, and
a central axis of the hollow cylinder forming the first portion is parallel to one of three coordinate axes in the reference coordinate system.

### Technical Scheme 10

The computer program product according to the technical scheme 9, wherein the target object model is an equation of the inner curved surface of the hollow cylinder.

### Technical Scheme 11

The computer program product according to the technical scheme 10, wherein the generation unit
constrains the central axis of the hollow cylinder represented by the equation in parallel with the coordinate axis being parallel to the central axis of the hollow cylinder forming the first portion,
generates an estimated curved surface minimizing a distance to each of the three-dimensional points included in the extraction point cloud data, and
generates the target object information representing a position and an orientation of the estimated curved surface.

### Technical Scheme 12

The computer program product according to any one of the technical schemes 1 to 5, wherein the target object model represents a three-dimensional shape of the first portion in the designated target object.

### Technical Scheme 13

The computer program product according to the technical scheme 12, wherein
the target object model is represented by a model coordinate system being different from the reference coordinate system, and
the generation unit calculates a transformation vector for performing coordinate transformation from the model coordinate system to the reference coordinate system, the transformation vector being calculated to minimize a distance between each of three-dimensional points included in the extraction point cloud data and the target object model under a condition that an orientation of the target object model matches an orientation defined for the first portion of the designated target object.

### Technical Scheme 14

The computer program product according to any one of the technical schemes 1 to 13, wherein
the programmed instructions cause the computer to further function as an orientation detection unit to detect an orientation of the first portion in the designated target object, and
the generation unit generates the target object information by fitting the target object model to the extraction point cloud data under a condition that an orientation of the target object model matches a detected orientation of the first portion in the designated target object.

### Technical Scheme 15

The computer program product according to any one of the technical schemes 1 to 14, wherein
the programmed instructions cause the computer to further function as a size calculation unit to calculate a size of the designated target object in the target object model on the basis of the target area and the target object information, and
the output unit outputs the size together with the target object information.

### Technical Scheme 16

The computer program product according to any one of the technical schemes 1 to 15, wherein the point cloud acquisition unit generates the three-dimensional point cloud data on the basis of the image data.

### Technical Scheme 17

The computer program product according to any one of the technical schemes 1 to 15, wherein the point cloud acquisition unit acquires, from a three-dimensional sensor device, the three-dimensional point cloud data in which a correspondence relationship with a pixel position in the image data is defined.

### Technical Scheme 18

An information processing apparatus comprising one or more hardware processors connected to a memory, the hardware processors being configured to function as:
an image acquisition unit to acquire image data;
a point cloud acquisition unit to acquire three-dimensional point cloud data including three-dimensional points, each of the three-dimensional points representing a three-dimensional position of an object included in the image data;
a coordinate system specifying unit to specify a reference coordinate system representing a reference of a three-dimensional position;
an area detection unit to detect, from the image data, a two-dimensional target area in which a designated target object is included;
an extraction unit to extract, from the three-dimensional point cloud data, extraction point cloud data representing a three-dimensional position of an object included in the target area;
a model acquisition unit to acquire a target object model being information obtained by modeling a shape of a first portion, the first portion being at least part of the designated target object;
a generation unit to generate target object information representing a position and an orientation of the target object model, each corresponding to a case where the target object model is arranged in a three-dimensional space to follow the designated target object; and
an output unit to output the target object information, wherein
a shape of the first portion of the designated target object is defined, and an orientation of the first portion is defined with respect to at least one of coordinate axes in the reference coordinate system, and
the generation unit generates the target object information by fitting the target object model to the extraction point cloud data under a condition that an orientation of the target object model matches an orientation defined for the first portion of the designated target object.

### Technical Scheme 19

An information processing method implemented by a computer, the method comprising:
acquiring image data;
acquiring three-dimensional point cloud data including three-dimensional points, each of the three-dimensional points representing a three-dimensional position of an object included in the image data;
specifying a reference coordinate system representing a reference of a three-dimensional position;
detecting, from the image data, a two-dimensional target area in which a designated target object is included;
extracting, from the three-dimensional point cloud data, extraction point cloud data representing a three-dimensional position of an object included in the target area;
acquiring a target object model being information obtained by modeling a shape of a first portion, the first portion being at least part of the designated target object;
generating target object information representing a position and an orientation of the target object model, each corresponding to a case where the target object model is arranged in a three-dimensional space to follow the designated target object; and
outputting the target object information, wherein
a shape of the first portion of the designated target object is defined, and an orientation of the first portion is defined with respect to at least one of coordinate axes in the reference coordinate system, and
the generating of the target object information is performed by fitting the target object model to the extraction point cloud data under a condition that an orientation of the target object model matches an orientation defined for the first portion of the designated target object.

What is claimed is:

1. A computer program product comprising a non-transitory computer-readable recording medium on which programmed instructions are recorded, the programmed instructions causing a computer to function as:
an image acquisition unit to acquire image data;
a point cloud acquisition unit to acquire three-dimensional point cloud data including three-dimensional points, each of the three-dimensional points representing a three-dimensional position of an object included in the image data;
a coordinate system specifying unit to specify a reference coordinate system representing a reference of a three-dimensional position;
an area detection unit to detect, from the image data, a two-dimensional target area in which a designated target object is included;
an extraction unit to extract, from the three-dimensional point cloud data, extraction point cloud data representing a three-dimensional position of an object included in the target area;
a model acquisition unit to acquire a target object model being information obtained by modeling a shape of a first portion, the first portion being at least part of the designated target object;
a generation unit to generate target object information representing a position and an orientation of the target object model, each corresponding to a case where the target object model is arranged in a three-dimensional space to follow the designated target object; and
an output unit to output the target object information, wherein
a shape of the first portion of the designated target object is defined, and an orientation of the first portion is defined with respect to at least one of coordinate axes in the reference coordinate system, and
the generation unit generates the target object information by fitting the target object model to the extraction point cloud data under a condition that an orientation of the target object model matches an orientation defined for the first portion of the designated target object.

2. The computer program product according to claim 1, wherein
the image data is generated by a camera installed in a mobile entity, and
the reference coordinate system has three coordinate axes, one of which is parallel to an optical axis of the camera.

3. The computer program product according to claim 1, wherein
the image data is generated by a camera installed in a mobile entity traveling on a road, and
the reference coordinate system has three coordinate axes, one of which is parallel to a lane marking on the road.

4. The computer program product according to claim 1, wherein
the image data is generated by a camera installed in a mobile entity, and
the reference coordinate system has three coordinate axes, one of which is parallel to a moving direction of the camera.

5. The computer program product according to claim 4, wherein the moving direction is calculated on the basis of a movement of the camera.

6. The computer program product according to claim 1, wherein the first portion of the designated target object is a plane and is parallel to one or two of three coordinate axes in the reference coordinate system.

7. The computer program product according to claim 6, wherein the target object model is an equation of the plane.

8. The computer program product according to claim 7, wherein the generation unit
constrains the plane represented by the equation in parallel with the coordinate axis being parallel to the first portion in the reference coordinate system,
generates an estimated plane minimizing a distance to each of the three-dimensional points included in the extraction point cloud data, and
generates the target object information representing a position and an orientation of the estimated plane.

9. The computer program product according to claim 1, wherein
the first portion of the designated target object has a shape of part of an inner curved surface of a hollow cylinder, and
a central axis of the hollow cylinder forming the first portion is parallel to one of three coordinate axes in the reference coordinate system.

10. The computer program product according to claim 9, wherein the target object model is an equation of the inner curved surface of the hollow cylinder.

11. The computer program product according to claim 10, wherein the generation unit
constrains the central axis of the hollow cylinder represented by the equation in parallel with the coordinate axis being parallel to the central axis of the hollow cylinder forming the first portion,
generates an estimated curved surface minimizing a distance to each of the three-dimensional points included in the extraction point cloud data, and
generates the target object information representing a position and an orientation of the estimated curved surface.

12. The computer program product according to claim 1, wherein the target object model represents a three-dimensional shape of the first portion in the designated target object.

13. The computer program product according to claim 12, wherein
the target object model is represented by a model coordinate system being different from the reference coordinate system, and
the generation unit calculates a transformation vector for performing coordinate transformation from the model coordinate system to the reference coordinate system, the transformation vector being calculated to minimize a distance between each of three-dimensional points included in the extraction point cloud data and the target object model under a condition that an orientation of the target object model matches an orientation defined for the first portion of the designated target object.

14. The computer program product according to claim 1, wherein
the programmed instructions cause the computer to further function as an orientation detection unit to detect an orientation of the first portion in the designated target object, and
the generation unit generates the target object information by fitting the target object model to the extraction point cloud data under a condition that an orientation of the target object model matches a detected orientation of the first portion in the designated target object.

15. The computer program product according to claim 1, wherein
the programmed instructions cause the computer to further function as a size calculation unit to calculate a size of the designated target object in the target object model on the basis of the target area and the target object information, and
the output unit outputs the size together with the target object information.

16. The computer program product according to claim 1, wherein the point cloud acquisition unit generates the three-dimensional point cloud data on the basis of the image data.

17. The computer program product according to claim 1, wherein the point cloud acquisition unit acquires, from a three-dimensional sensor device, the three-dimensional point cloud data in which a correspondence relationship with a pixel position in the image data is defined.

18. An information processing apparatus comprising one or more hardware processors connected to a memory, the hardware processors being configured to function as:
an image acquisition unit to acquire image data;
a point cloud acquisition unit to acquire three-dimensional point cloud data including three-dimensional points, each of the three-dimensional points representing a three-dimensional position of an object included in the image data;
a coordinate system specifying unit to specify a reference coordinate system representing a reference of a three-dimensional position;
an area detection unit to detect, from the image data, a two-dimensional target area in which a designated target object is included;
an extraction unit to extract, from the three-dimensional point cloud data, extraction point cloud data representing a three-dimensional position of an object included in the target area;
a model acquisition unit to acquire a target object model being information obtained by modeling a shape of a first portion, the first portion being at least part of the designated target object;
a generation unit to generate target object information representing a position and an orientation of the target object model, each corresponding to a case where the target object model is arranged in a three-dimensional space to follow the designated target object; and
an output unit to output the target object information, wherein
a shape of the first portion of the designated target object is defined, and an orientation of the first portion is defined with respect to at least one of coordinate axes in the reference coordinate system, and
the generation unit generates the target object information by fitting the target object model to the extraction point cloud data under a condition that an orientation of the target object model matches an orientation defined for the first portion of the designated target object.

19. An information processing method implemented by a computer, the method comprising:
acquiring image data;
acquiring three-dimensional point cloud data including three-dimensional points, each of the three-dimensional points representing a three-dimensional position of an object included in the image data;
specifying a reference coordinate system representing a reference of a three-dimensional position;
detecting, from the image data, a two-dimensional target area in which a designated target object is included;
extracting, from the three-dimensional point cloud data, extraction point cloud data representing a three-dimensional position of an object included in the target area;
acquiring a target object model being information obtained by modeling a shape of a first portion, the first portion being at least part of the designated target object;
generating target object information representing a position and an orientation of the target object model, each corresponding to a case where the target object model is arranged in a three-dimensional space to follow the designated target object; and
outputting the target object information, wherein a shape of the first portion of the designated target object is defined, and an orientation of the first portion is defined with respect to at least one of coordinate axes in the reference coordinate system, and
the generating of the target object information is performed by fitting the target object model to the extraction point cloud data under a condition that an orientation of the target object model matches an orientation defined for the first portion of the designated target object.
